(19) United States
(12) Patent Application Publication
(10) Pub. No.: US 2008/0145950 A1
(43) Pub. Date: Jun. 19, 2008

(54) Method for extracting an analyte

(76) Inventor: Douglas T. Gjerde, Saratoga, CA (US)

Correspondence Address: PHYNEXUS, INC., 3670 CHARTER PARK DRIVE, SAN JOSE, CA, 95136, US

(21) Appl. No.: 12/002,242

(22) Filed: Dec. 13, 2007

Related U.S. Application Data
(60) Provisional application No. 60/875,083, filed on Dec. 14, 2006.

(51) Int. Cl. G01N 1/28

(52) U.S. Cl. 436/178

(57) ABSTRACT

The instant invention provides a multi-step method for using an extraction device to extract an analyte from a liquid sample. In particular, the invention provides methods for performing a pre-elution wash step to increase the efficiency of the elution step and the yield and concentration of the analyte.

### CROSS REFERENCE TO RELATED APPLICATIONS

This application claims priority to and benefit of U.S. Provisional Patent Application No. 60/875,083 filed Dec. 14, 2006, the disclosure of which is incorporated herein by reference in their entirety for all purposes.

### FIELD OF THE INVENTION

This invention relates to a method for extracting an analyte from a liquid sample, wherein the process is characterized by a plurality of steps. In particular, the invention relates to a pre-elution wash step that can affect the efficiency of the extraction.

### BACKGROUND OF THE INVENTION

Solid phase extraction is a powerful technology for purifying and concentrating analytes, including biomolecules. For example, it is one of the primary tools used for preparing protein samples prior to analysis by any of a variety of analytical techniques, including mass spectrometry, surface plasmon resonance, nuclear magnetic resonance, x-ray crystallography, and the like. With these techniques, typically only a small volume of highly-concentrated sample is required, however, it is often critical that interfering contaminants be removed from the sample. Thus, sample preparation methods are needed that permit the purification and concentration of samples. This is especially important for determining structure and function of biological materials such as proteins, polypeptides, nucleic acids as well as other materials.

The subject invention involves methods for extracting an analyte from a sample solution using an extraction device such as a pipette tip column. In particular, the invention relates to methods for obtaining a small volume of highly-concentrated analyte. For example, extraction methods often utilize low pH desorption solutions during the elution step to disrupt the binding of an analyte to an affinity matrix. However, if the column pH is neutral or high prior to elution, a portion of the desorption solution acidity will be used to lower the pH of the column prior to eluting the analyte. As a result, it is necessary to use a larger volume of elution buffer, making it difficult to obtain the analyte in a high concentration.

To solve this problem, a pre-elution wash solution is used prior to elution of the bound analyte from the extraction device. The primary function of the pre-elution wash solution is to ensure that the column is properly conditioned for the elution step. A pre-elution wash solution can remove background components left behind after the previous step (sample loading or column washing) that could potentially interfere with efficient elution. Use of pre-elution wash solution to remove buffering components from the column is particularly critical when small volumes of desorption solution are used to elute the analyte. While a large volume of desorption solution can effectively dilute or change the pH of any liquid remaining on the column from the sample or wash solution, this is not the case for small volumes of desorption solution.

These methods, and the related devices and reagents, will be of particular interest to the life scientist, since they provide a powerful technology for purifying, concentrating and analyzing biomolecules and other analytes of interest. However, the methods, devices and reagents are not limited to use in the biological sciences, and can find wide application in a variety of preparative and analytical contexts.

### BRIEF DESCRIPTION OF THE FIGURE

FIG. 1 depicts the set-up of the MEA Personal Purification System™ for sample processing in Example 1.

### DESCRIPTION OF SPECIFIC EMBODIMENTS OF THE INVENTION

Before describing the present invention in detail, it is to be understood that this invention is not limited to specific embodiments described herein. It is also to be understood that the terminology used herein for the purpose of describing particular embodiments is not intended to be limiting. As used in this specification and the appended claims, the singular forms “a”, “an” and “the” include plural referents unless the context clearly dictates otherwise.

Unless defined otherwise, all technical and scientific terms used herein have the same meaning as commonly understood by one of ordinary skill in the art to which the invention pertains. Although any methods and materials similar or equivalent to those described herein can be used in the practice or testing of the present invention, specific examples of appropriate materials and methods are described herein.

### DEFINITIONS

In describing and claiming the present invention, the following terminology will be used in accordance with the definitions set out below.

“Analyte” refers to a component of a sample which is desirably retained and detected. The term can refer to a single component or a set of components in the sample.

The term “biomolecule” as used herein refers to biomolecule derived from a biological system. The term includes biological macromolecules, such as a proteins, peptides, and nucleic acids.

A “solvent” is defined herein as a liquid, capable of dissolving another substance.

The terms “extraction column” and “extraction tip” as used herein are defined as a column device used in combination with a pump, the column device containing a bed of solid phase extraction material, i.e., extraction medium.

The term “bed volume” as used herein is defined as the volume of a bed of extraction medium in an extraction column. Depending on how densely the bed is packed, the volume of the extraction medium in the column bed is typically about one third to two thirds of the total bed volume.

The term “dead volume” as used herein with respect to a column is defined as the interstitial volume of the extraction bed, tubes, membrane or frits, and passageways in a column. The term “sample volume”, as used herein is defined as the volume of the liquid of the original sample solution from which the analytes are separated or purified.

The term “interstitial volume” of the bed refers to the volume of the bed of extraction medium that is accessible to solvent, e.g., aqueous sample solutions, wash solutions and desorption solvents. It is the volume between the beads and does not include the volume of liquid used to swell or hydrate the beads. For example, in the case where the extraction medium is a chromatography bead (e.g., agarose or sepharose), the interstitial volume of the bed constitutes the solvent accessible volume between the beads, as well as any solvent accessible internal regions of the bead, e.g., solvent accessible pores. The interstitial volume of the bed represents the minimum volume of liquid required to saturate the column bed and is typically equal to ⅓ to ⅔ of the bed volume. Well-packed beds have less space between the beads and hence generally have lower interstitial volumes.

The term “sample solution” is defined herein as a solution containing an analyte. The terms “solution” and “solvent” are used interchangeably herein.

The terms “desorption solvent,” “desorption solution,” “elution liquid” and the like are used interchangeably herein and are defined as the solution applied to the extraction column to obtain the purified analyte. The term “elution volume” as used herein is defined as the volume of desorption solvent or elution liquid into which the analytes are desorbed and collected.

The term “pre-elution wash” is defined herein as a solution applied to the extraction column after the sample loading and prior to the desorption step that removes residual ions or buffer that would otherwise react or interact with the elution buffer reducing its effectiveness.

The term “enrichment factor” as used herein is defined as the ratio of the sample volume divided by the elution volume, assuming that there is no contribution of liquid coming from the dead volume. To the extent that the dead volume either dilutes the analytes or prevents complete adsorption, the enrichment factor is reduced.

“Saline solution” is defined as a solution containing a salt or salts.

The term “base” is defined as a liquid that can neutralize an acid.

In various embodiments, the subject invention provides extraction devices, solutions, and methods for extracting, purifying, processing and/or concentrating an analyte or analytes of interest. Certain embodiments of the invention are particularly suited to the processing of biological samples, where the analyte of interest is a biomolecule. Of particular relevance are biological macromolecules such as proteins, polypeptides, or complexes containing one or more of these moieties. Analytes purified using the methods of the invention can retain biological activity and be further characterized using a variety of analytical techniques.

### Extraction Devices

In accordance with the present invention there may be employed conventional chemistry, biological and analytical techniques within the skill of the art. Such techniques are explained fully in the literature. See, e.g. Chromatography, 5th edition, PART A: FUNDAMENTALS AND TECHNIQUES, editor: E. Heftmann, Elsevier Science Publishing Company, New York (1992); ADVANCED CHROMATOGRAPHIC AND ELECTROMIGRATION METHODS IN BIOSCIENCES, editor: Z. Deyl, Elsevier Science BV, Amsterdam, The Netherlands, (1998); CHROMATOGRAPHY TODAY, Colin F. Poole and Salwa K. Poole, and Elsevier Science Publishing Company, New York, (1991).

In some embodiments of the subject invention the extraction device is a column. In certain embodiments of the invention the column is a pipette tip column. Pipette tip columns are available from PhyNexus, Inc., San Jose, Calif. (http://phynexus.com) and are described in detail in published U.S. Patent Application US 20050019951 which is incorporated by reference herein. Non-limiting examples of suitable columns are presented herein. It is to be understood that the extraction devices and methods of the subject invention are not to be construed as limited to use with columns. For example, the invention is applicable to use with a packed bed of extraction medium as a component of a multi-well plate.

In those embodiments in which the extraction device is a column, the bed volume of the extraction medium used in the column may be small, typically in the range of 0.1-1000 μL, preferably in the range of 0.1-100 μL, e.g., in a range having a lower limit of 0.1, 0.5, 1, 1.5, 2, 2.5, 3, 5 or 10 μL; and an upper limit of 5, 10, 15, 20, 30, 40 50, 60, 70, 80, 90, 100, 150, 200, 300, 400 or 500 μL. The low bed volume contributes to a low interstitial volume of the bed, reducing the dead volume of the column, thereby facilitating the recovery of analyte in a small volume of desorption solvent. In certain embodiments in which the extraction device is a column, the bed volume of the extraction medium used in the column may be larger. In these embodiments, the upper limit of bed volume can be 1, 5, 10, 15, 20, 25, 30, 35, 40, 45, 50, 75, or 100 ml.

In some embodiments, one of the open ends of the extraction device sometimes referred to herein as the open upper end of the extraction device, is adapted for attachment with a pump, either directly or indirectly. In some embodiments of the invention the upper open end is operatively attached to a pump, whereby the pump can be used for aspirating (i.e., drawing) a fluid into the extraction device through the open lower end of the column, and optionally for discharging (i.e., expelling) fluid out through the open lower end of the device. Thus, it is a feature of certain embodiments of the present invention that fluid enters and exits the extraction column through the same open end of the column, typically the open lower end. This is in contradistinction with the operation of some extraction devices, where fluid enters the column through one open end and exits through the other end after traveling through a bed of extraction medium, i.e., similar to conventional column chromatography.

In other embodiments of the present invention, fluid enters the extraction device through one end and exits through the other. In some embodiments, the invention provides extraction methods that involve a hybrid approach; that is, one or more fluids enter the extraction device through one end and exit through the other, and one more fluids enter and exit the extraction device through the same open end of the extraction device, e.g., the lower end. Thus, for example, in some methods the sample solution and/or wash solutions are introduced through the top of the extraction device and exit through the bottom end, while the desorption solution enters and exits through the bottom opening of the extraction device. The fluid can be a liquid, such as a sample solution, wash solution, pre-elution wash solution or desorption solution. The fluid can also be a gas, e.g., air used to blow liquid out of the extraction column.

### Extraction Media

The extraction medium used in the column is preferably a form of water-insoluble particle (e.g., a porous or non-porous bead) that has an affinity for an analyte of interest. Typically the analyte of interest is a protein or peptide.

Examples of suitable extraction media include resin beads used for extraction and/or chromatography. Preferred resins include gel resins, pellicular resins, and macroporous resins. The term “gel resin” refers to a resin comprising low-crosslinked bead materials that can swell in a solvent, e.g., upon hydration. Crosslinking refers to the physical linking of the polymer chains that form the beads. The physical linking is normally accomplished through a crosslinking monomer that contains bi-polymerizing functionality so that during the polymerization process, the molecule can be incorporated into two different polymer chains. The degree of crosslinking for a particular material can range from 0.1 to 30%, with 0.5 to 10% normally used. 1 to 5% crosslinking is most common. A lower degree of crosslinking renders the bead more permeable to solvent, thus making the functional sites within the bead more accessible to analyte. So in some embodiments the extraction medium is a resin, such as a gel resin that has an affinity for the analyte. Common gel resins include agarose, sepharose, polystyrene, polyacrylate, cellulose and other substrates.

Gel resins can be non-porous or micro-porous beads. Examples of resin beads include Protein A, Protein G, Protein L, MEP Hypercel™ beads (e.g., for IgG protein purification) and IMAC resins. Silica beads are also suitable.

Examples of specific affinity binding agents include proteins having an affinity for antibodies, Fc regions and/or Fab regions such as Protein G, Protein A, Protein A/G, and Protein L; chelated metals such as metal-NTA chelate (e.g., Nickel NTA, Copper NTA, Iron NTA, Cobalt NTA, Zinc NTA), metal-IDA chelate (e.g., Nickel IDA, Copper IDA, Iron IDA, Cobalt IDA) and metal-CMA (carboxymethylated aspartate) chelate (e.g., Nickel CMA, Copper CMA, Iron CMA, Cobalt CMA, and Zinc CMA).

In some embodiments of the invention, the affinity binding reagent is one that recognizes one or more of the many affinity groups used as affinity tags in recombinant fusion proteins. Examples of such tags include poly-histidine tags (e.g., the 6×-His tag), which can be extracted using a chelated metal such as Ni-NTA- peptide sequences (such as the FLAG epitope) that are recognized by an immobilized antibody; biotin, which can be extracted using immobilized avidin or streptavidin; “calmodulin binding peptide” (or, CBP), recognized by calmodulin charged with calcium; glutathione S-transferase protein (GST), recognized by immobilized glutathione; maltose binding protein (MBP), recognized by amylose; the cellulose-binding domain tag, recognized by immobilized cellulose; a peptide with specific affinity for S-protein (derived from ribonuclease A); and the peptide sequence tag CCxxCC (where xx is any amino acid, such as RE), which binds to the affinity binding agent bis-arsenical fluorescein (FlAsH dye).

The references listed below show examples of the types of affinity groups that can be employed in the practice of this invention are hereby incorporated by reference herein in their entireties. Antibody Purification Handbook, Amersham Biosciences, Edition AB, 18-1037-46 (2002); Protein Purification Handbook, Amersham Biosciences, Edition AC, 18-1132-29 (2001); Affinity Chromatography Principles and Methods, Amersham Pharmacia Biotech, Edition AC, 18-1022-29 (2001); The Recombinant Protein Handbook, Amersham Pharmacia Biotech, Edition AB, 18-1142-75 (2002); and Protein Purification: Principles, High Resolution Methods, and Applications, Jan-Christen Janson (Editor), Lars G. Ryden (Editor), Wiley, John & Sons, Incorporated (1989).

### Solvents

Extractions of the invention typically involve the loading an extraction device with an analyte contained in a sample solution, performing an optional rinse with a wash solution, followed by a rinse with a pre-elution wash solution, and finally, elution of the analyte into a desorption solution. In some embodiments, the solutions passed through the extraction device are sufficiently gentle that the native structure and function of the analyte is retained upon desorption from the extraction medium. The nature of these solutions will now be described in greater detail.

The sample solution typically consists of the analyte dissolved in a solvent in which the analyte is soluble, and in which the analyte will bind to the extraction surface. Preferably, the binding is strong; resulting in the binding of a substantial portion of the analyte, and optimally substantially all of the analyte will be bound under the loading protocol used in the procedure. The solvent should also be gentle, so that the native structure and function of the analyte is retained upon desorption from the extraction surface. Typically, in the case where the analyte is a biomolecule, the solvent is an aqueous solution, typically containing a buffer to solubilize and stabilize the biomolecule. Examples of sample solutions include cells lysates, hybridoma growth medium, cell-free translation or transcription reaction mixtures, extracts from tissues, organs, or biological samples, and extracts derived from biological fluids.

It is important that the sample solution not only solubilize the analyte, but also that it is compatible with binding to the extraction phase. For example, the ionic strength of the sample solution should be buffered to an appropriate pH such that the analyte will bind to the resin. Depending upon the nature of the sample and extraction process, other constituents might be beneficial, e.g., reducing agents, detergents, stabilizers, denaturants, chelators, metals, etc.

In certain embodiments of the invention a wash solution is applied to the extraction device after the sample solution. In other embodiments the wash step is omitted. The function of the wash solution is to ensure that the majority of the background components, such as non-specifically bound proteins are removed from the surface of the extraction medium and are washed away from the column. However, wash solutions should be carefully selected to ensure minimal loss or damage to the bound analyte. In certain embodiments of the invention, the properties of the wash solution are intermediate between that of the sample and desorption solutions. In some embodiments the wash solution is a buffer.

In the case of Ni-NTA columns for the purification of His-tagged recombinant antibodies, the concentration of imidazole in the phosphate-buffered saline (PBS) wash buffer is critical for ensuring that non-specifically bound proteins are removed from the Ni by displacing them with imidazole. The optimum concentration can vary from 5-50 mM. In the case of Protein A or Protein G columns for purification of whole IgGs the concentration of NaCl in the PBS wash buffer is critical for ensuring that proteins that are bound non-specifically through (primarily) ion-exchange mechanisms are washed from the resin surface and the optimum concentration can vary from 0.1-1 M.

A pre-elution wash solution is used after the wash step or after the loading step if the wash is omitted. The primary function of the pre-elution wash solution is to ensure that the column is properly conditioned prior to elution of the bound analyte. The pre-elution wash solution removes background components left behind after the previous step (sample loading or column washing) that could potentially interfere with efficient elution by the desorption solution.

The pre-elution wash solution removes buffer or base from the column to ensure the pH of the desorption solution will not be altered during the desorption step. For example, when low pH elution is being applied in IMAC, Protein A and Protein G purifications, the pre-elution wash can be an un-buffered saline wash of 0.14 M NaCl. This maintains conditions that are conducive to protein solubility, but also serves to remove the PBS buffer components from the wash. If these buffer components are not removed, it can result in the low pH elution solution being buffered to a higher pH where elution is no longer effective.

Use of pre-elution wash solution to remove buffering components from the column is particularly critical when small volumes of desorption solution are used to elute the analyte. While a large volume of desorption solution can effectively dilute any liquid remaining on the column from the sample or wash solution, this is not the case for small volumes of desorption solution.

The desorption solution should be just strong enough to quantitatively desorb the analyte. If strongly bound interfering materials are present, they should be left behind. The desorption solutions is chosen to be compatible with the analyte and the ultimate detection method. In some embodiments the analyte is eluted from the extraction medium using a desorption solution having a low pH. The pH of the desorption solution can be less than 5.5, less than 5, less than 4.5, less than 4.0, less than 3.5, less than 3, less than 2.5, less than 2, less than 1.5, less than 1, or less than 0.5.

### Methods for Using the Extraction Columns

Generally the first step in an extraction procedure of the invention will involve introducing a sample solution containing an analyte of interest into a packed bed of extraction medium, typically in the form of a column as described above. In certain embodiments the packed bed of extraction, medium is contained within a pipette tip column. The sample solution can be any solution containing an analyte of interest. The invention is particularly useful for extraction and purification of biological molecules; hence the sample solution is often of biological origin. Non-limiting examples of sample solutions include cell lysates, hybridoma cell culture supernatants, viruses, tissues, organs or organisms including lysates, homogenates or body fluid samples such as blood, urine or cerebrospinal fluid.

The sample can be conveniently introduced into the separation bed by pumping the solution through the column. Note that the volume of sample solution can be much larger than the bed volume. The sample solution can optionally be passed through the column more than one time, e.g., by being pumped back and forth through the bed. This can improve adsorption of analyte, which can be particularly useful in cases where the analyte is of low abundance and hence maximum sample recovery is desired.

After the sample solution has been introduced into the bed and analyte allowed to adsorb, the sample solution is substantially evacuated from the bed, leaving the bound analyte. It is not necessary that all sample solution be evacuated from the bed, but diligence in removing the solution can improve the purity of the final product. An optional wash step between the adsorption and the pre-elution wash can also improve the purity of the final product. Typically water or a buffer is used for the wash solution. The wash solution is preferably one that will, with a minimal desorption of the analyte of interest, remove excess matrix materials, lightly adsorbed or non-specifically adsorbed materials so that they do not come off in the elution cycle as contaminants. The wash cycle can include a solvent or solvents having a specific pH, or containing components that promote removal of materials that interact lightly with the extraction phase. In some cases, several wash solvents might be used in succession to remove specific material, e.g., PBS followed by water. These cycles can be repeated as many times as necessary. In other cases, where light contamination can be tolerated, a wash cycle can be omitted.

Next a pre-elution wash solution is introduced into the extraction column. As described above, the pre-elution wash conditions the column by removing any background components remaining after sample loading or column washing that might interfere with efficient elution. The pre-elution wash solution removes buffer from the column to ensure the pH of the desorption solution will not be altered during the desorption step. Use of the pre-elution wash solution allows for desorption in a very small volume which in turn, permits high concentrations of analyte to be obtained.

The volume of desorption solvent used can be very small, approximating the interstitial volume of the bed of extraction medium or less. In some embodiments of the invention the amount of desorption solvent used is less than 10-fold greater than the interstitial volume of the bed of extraction medium, less than 5-fold greater than the interstitial volume of the bed of extraction medium, less than 4-fold greater than the interstitial volume of the bed of extraction medium, less than 3-fold greater than the interstitial volume of the bed of extraction medium, less than 2-fold greater than the interstitial volume of the bed of extraction medium, or less than the interstitial volume of the bed of extraction medium. For example, ranges of desorption solvent volumes appropriate for use with the invention can have a lower limit of 1%, 5%, 10%, 15%, 20%, 30%, 40%, 50%, 60%, 70%, 80%, 90%, 100%, 150%, 200% or 300% of the interstitial volume, and an upper limit of 50%, 100%, 200%, 300%, 400%, 500%, 500%, 600%, 700%, 800%, or 1000% of the interstitial volume, e.g., 10 to 200% of the interstitial volume, 20 to 100% of the interstitial volume, 10 to 50%, 100% to 500%, 200 to 1000%, etc., of the interstitial volume.

Alternatively, the volume of desorption solvent used can be quantified in terms of the bed volume (i.e., the total volume of bed of extraction medium plus interstitial space) rather than percent of interstitial volume. For example, ranges of desorption solvent volumes appropriate for use with the invention can have a lower limit of 1%, 5%, 10%, 15%, 20%, 30%, 40%, 50%, 60%, 70%, 80%, 90%, 100%, 150%, 200% or 300% of the bed volume, and an upper limit of 50%, 100%, 200%, 300%, 400%, 500%, 500%, 600%, 700%, 800%, or 1000% of the bed volume, e.g., 10 to 200% of the bed volume, 20 to 100% of the bed volume 10 to 50%, 100% to 500%, 200 to 1000%, etc., of the bed volume. Alternatively, the volume of desorption solvent used can be less than six times the volume of the bed of extraction medium, less than five times the volume of the bed of extraction medium, less than four times the volume of the bed of extraction medium, less than three times the volume of the bed of extraction medium, less than two times the volume of the bed of extraction medium, or less than the volume of the bed of extraction medium.

In some embodiments of the invention, the amount of desorption solvent introduced into the column is less than 100 μL, less than 20 μL, less than 15 μL, less than 10 μL, less than 5 μL, or less than 1 μL. For example, ranges of desorption solvent volumes appropriate for use with the invention can have a lower limit of 0.1 μL, 0.2 μL, 0.3 μL, 0.5 μL, 1 μL, 2 μL, 3 μL, 5 μL, or 10 μL, and an upper limit of 2 μL, 3 μL, 5 μL, 10 μL, 15 μL, 20 μL, 30 μL, 50 μL, or 100 μL, e.g., in between 1 and 15 μL, 0.1 and 10 μL, or 0.1 and 2 μL.

### Analytical Techniques

Extraction devices and associated methods of the invention find particular utility in preparing samples of analyte for analysis or detection by a variety of analytical techniques. In particular, the methods are useful for purifying an analyte, class of analytes, aggregate of analytes, etc, from a biological sample, e.g., a biomolecule originating in a biological fluid. It is particularly useful with techniques that require small volumes of pure, concentrated analyte. In many cases, the results of these forms of analysis are improved by increasing analyte concentration. In some embodiments of the invention the analyte of interest is a protein, and the extraction serves to purify and concentrate the protein prior to analysis. The methods are particular suited for use with label-free detection methods or methods that require functional, native (i.e., non-denatured protein), but are generally useful for any protein or nucleic acid of interest.

These methods are particularly suited for application to proteomic studies, the study of protein-protein interactions, and the like. The elucidation of protein-protein interaction networks, preferably in conjunction with other types of data, allows assignment of cellular functions to novel proteins and derivation of new biological pathways. See, e.g., Curr. Protein Pept. Sci. 2003 4(3): 159-81.

Many of the current detection and analytical methodologies can be applied to very small sample volumes, but often require that the analyte be enriched and purified in order to achieve acceptable results. Conventional sample preparation technologies typically operate on a larger scale, resulting in waste because they produce more volume than is required. This is particularly a problem where the amount of starting sample is limited, as is the case with many biomolecules. These conventional methods are generally not suited for working with the small volumes required for these new methodologies. For example, the use of conventional packed bed chromatography techniques tends to require larger solvent volumes, and are not suited to working with such small sample volumes for a number of reasons, e.g., because of loss of sample in dead volumes, on frits, etc. See published U.S. Patent Application No. US2004/0126890 for a more in-depth discussion of problems associated with previous technologies in connection with the enrichment and purification of low abundance biomolecules.

In certain embodiments, the invention involves the direct analysis of analyte eluted from an extraction column without any intervening sample processing step, e.g., concentration, desalting or the like, provided the method is designed correctly. Thus, for example, a sample can be eluted from a column and directly analyzed by MS, SPR or the like. This is a distinct advantage over other sample preparation methods that require concentration, desalting or other processing steps before analysis. These extra steps can increase the time and complexity of the experiment, and can result in significant sample loss, which poses a major problem when working with low abundance analytes and small volumes.

One example of such an analytical technique is mass spectroscopy (MS). In the application of mass spectrometry for the analysis of biomolecules, the molecules are transferred from the liquid or solid phases to gas phase and to vacuum phase. Since many biomolecules are both large and fragile (proteins being a prime example), two of the most effective methods for their transfer to the vacuum phase are matrix-assisted laser desorption ionization (MALDI) or electrospray ionization (ESI). Some aspects of the use of these methods, and sample preparation requirements, are discussed in more detail in published U.S. Patent Application No. US2004/0126890. In general ESI is more sensitive, while MALDI is faster. Significantly, some peptides ionize better in MALDI mode than ESI, and vice versa (Genome Technology, June 2002, p 52). The extraction methods and devices of the instant invention are particularly suited to preparing samples for MS analysis, especially biomolecule samples such as proteins. An important advantage of the invention is that it allows for the preparation of an enriched sample that can be directly analyzed, without the need for intervening process steps, e.g., concentration or desalting.

In some embodiments, the invention is used to prepare an analyte for use in an analytical method that involves the detection of a binding event on the surface of a solid substrate. These solid substrates are generally referred to herein as “binding detection chips,” examples of which include hybridization microarrays and various protein chips. As used herein, the term “protein chip” is defined as a small plate or surface upon which an array of separated, discrete protein samples (or “dots”) are to be deposited or have been deposited. In general, a chip bearing an array of discrete ligands (e.g., proteins) is designed to be contacted with a sample having one or more biomolecules which may or may not have the capability of binding to the surface of one or more of the dots, and the occurrence or absence of such binding on each dot is subsequently determined. A reference that describes the general types and functions of protein chips is Gavin MacBeath, Nature Genetics Supplement, 32:526 (2002). See also Ann. Rev. Biochem., 2003 72:783-812.

Before describing several exemplary embodiments of the invention, it is to be understood that the invention is not limited to the details of construction or process steps set forth in the following description. The invention is capable of other embodiments and of being practiced or being carried out in various ways.

All publications and patent applications mentioned in this specification are herein incorporated by reference to the same extent as if each individual publication or patent application was specifically and individually indicated to be incorporated by reference.

Having now generally described the invention, the same will be more readily understood through reference to the following examples, which are provided by way of illustration, and are not intended to be limiting of the present invention, unless so specified.

### EXAMPLES

The following preparations and examples are given to enable those skilled in the art to more clearly understand and practice the present invention. They should not be construed as limiting the scope of the invention, but merely as being illustrative and representative thereof.

### Example 1

### Optimization of Ubiquitin Purification with IMAC Pipette Tip Columns Using Low pH Citrate Elution

In this example, optimum conditions are studied for the purification of ubiquitin from an E. coli lysate. 20 μg of His-tagged ubiquitin is spiked into 200 μL of an E. coli lysate, with the pH adjusted to 7.4 by the addition of a volume of 5× buffer (25 mM imidazole, 50 mM NaH₂PO₄, 1.5 M NaCl, pH 7.4) equal to one quarter of the total volume of ubiquitin-spiked lysate. The purification method is optimized with regard to three independent variable factors: the concentration of imidazole in the wash, and the concentration and pH of a citrate elution buffer.

The extraction process is performed using an MEA automated purification system and PHYTIP 200+ pipette tip-based IMAC extraction columns (PhyNexus, Inc.). PhyNexus developed the PhyTip MEA Personal Purification System for fully automated protein purification and enrichment. When used with the PhyNexus Operating Software, this system offers a range of flow rates that maximizes the purification and enrichment efficiency of the various affinity resins available for PhyTip columns. The MEA Personal Purification System has fully programmable positioning of the 12 channel pipettor and the ability to place samples, PhyTip columns, wash stations and elution plates in any available position. The MEA instrument is used to perform the capture, purification and elution steps as follows.

### Capture

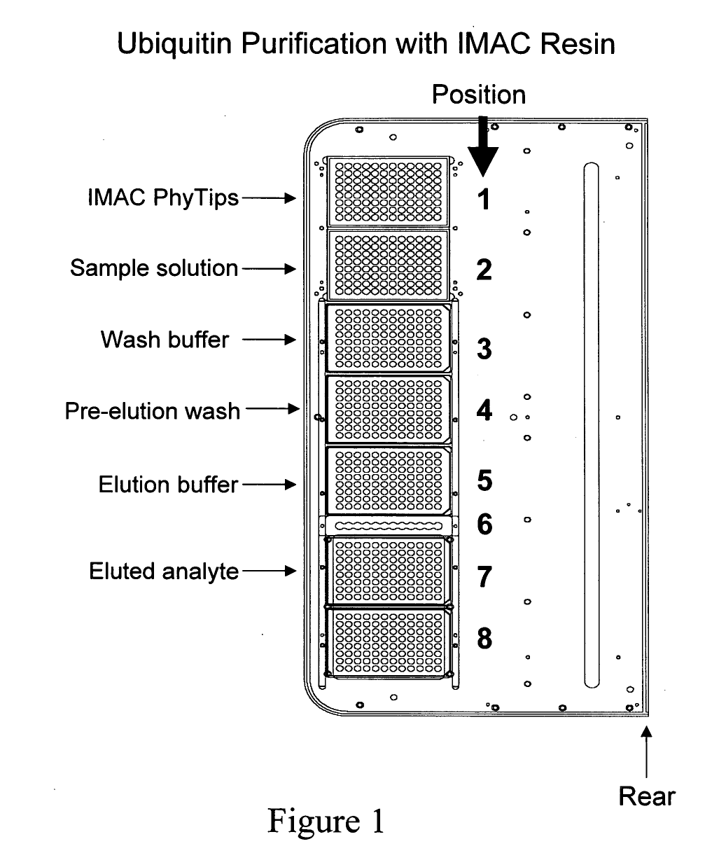

A standard 96-well microplate is arrayed with 96 aliquots of the pH-adjusted, ubiquitin-spiked E. Coli lysates described above and placed in position 2 (FIG. 1). The 96-well plate is comprised of rows A through H and columns 1 through 12. A box of 96 PhyTip IMAC columns is placed in Position 1 of the MEA instrument deck. The MEA instrument is programmed to perform the capture protocol at a flow rate of 250 μL/min. Each capture cycle is comprised of one aspiration step and one dispensing step. The capture protocol for rows A-H is eight cycles i.e. the E. coli lysate is aspirated and dispensed through the lower end of the PhyTip column eight times.

### Wash

The wash process for purification is optimized by varying the concentration of imidazole in the wash buffer. A 96-well microplate is placed into position 3 on the instrument deck and arrayed with 200 μL aliquots of wash buffers varying in the concentration of imidazole. Rows A and B have 0 mM imidazole in the wash buffer (10 mM NaH₂PO₄, 140 mM NaCl, pH 7.4), rows C and D have 5 mM (5 mM imidazole, 2.5 mM NaH₂PO₄, 7.5 mM NaCl, pH 7.4), rows E and F have 10 mM (10 mM imidazole, 5 mM NaH₂PO₄, 15 mM NaCl, pH 7.4), and rows G and H have 20 mM (20 mM imidazole, 10 mM NaH₂PO₄, 30 mM NaCl, pH 7.4). The MEA instrument is programmed to run 2 cycles of wash buffer through each tip column, at flow rates of 500 μL/min.

### Pre-Elution Wash

A second microplate arrayed with water in each well to remove any residual imidazole is positioned in position 4 of the instrument deck. The MEA instrument is programmed to repeat the same protocol as used in the wash step; the water is aspirated and dispensed two times.

### Elution

The elution step is optimized by varying the pH and concentration of sodium citrate in a citrate elution buffer. A 96 well microplate is placed into position 5 on the instrument deck and arrayed with 20 μL aliquots of citrate elution buffers varying in pH and sodium citrate concentration. The pH is adjusted with NaCl. The concentration range of citrate is 50, 100, 150, 200, 250, and 300 mM in columns 1-6 and again in 7-12. Columns 1-6 are adjusted to pH 3.0 citrate and columns 7-12 are adjusted to pH 4.5. The MEA instrument is programmed to run 2 cycles of elution buffer through each tip column (at flow rates of 500 μL/min), and then to expel the eluant into a well in a microplate positioned at position 7 on the MEA instrument deck. Each eluant is expelled into the same well position as that in which the original sample was arrayed in the sample tray.

After the MEA instrument performs the programmed purification protocol for the 96 samples, and the amount of total purified ubiquitin purified from each extraction is quantified by HPLC. The eluting power of citrate steadily increases with increasing concentration. 50 mM citrate and 100 mM citrate are poor eluting buffers although 100 mM citrate will give some useable protein. Greater amounts of protein are achieved with 150-300 mM citrate with 300 mM citrate giving the greatest amount of protein corresponding to approximately 70% yield. Both pH 3.0 and 4.5 citrate solutions give acceptable recoveries (excluding 50 and 100 mM citrate) with pH 4.5 citrate solutions giving approximately 15-20% higher yields than pH 3.0 citrate.

### Example 2

### Optimization of Capture Cycle Number, Flow Rate, and Elution Cycle Number, and Elution Volumes for Protein A Pipette Tip Columns

In this example, optimum conditions are studied for the purification of IgG from an E. coli lysate. 20 μg of IgG is spiked into 200 μL of an E. coli lysate, with the pH adjusted to 7.4 by the addition of a volume of 5× buffer (25 mM imidazole, 50 mM NaH₂PO₄, 1.5 M NaCl, pH 7.4) equal to ¼ the total volume of IgG-spiked lysate. The purification method is optimized with regard to three independent variable factors: (1) capture flow rate, (2) number of capture cycles, (3) elution buffer pH, and (4) the number of elution cycles.

The extraction process is performed using an MEA automated purification system and PHYTIP 200+ pipette tip-based Protein A extraction columns (PhyNexus, Inc.) as described in Example 1.

### Capture

In this example, the flow rate is adjusted to 100 μL/min and 200 μL/min. The number of capture cycles varies between 2, 4, 6 and 8. Rows A-D have a capture flow rate of 100 μL/min and rows E-H have a capture flow rate of 200 μL/min.

### Wash

The wash process for purification is the same for all 96 wells. 200 μL of pH 7.4 PBS wash is used with 2 cycles, each at flow rates of 500 μL/min.

### Pre-Elution Wash

In this pre-elution wash, 100 mM saline is used to remove any residual pH 7.4 PBS from the wash. 200 μL of the saline pre-elution wash is run with 2 cycles, each at flow rates of 500 μL/min.

### Elution

The final elution step is performed with an elution buffer (111 mM NaH₂PO₄, 140 mM NaCl in 14.8 mM H₃PO₄), adjusted to either pH 2.5 or pH 3.0. The buffer has a pH of 2.5 in columns 1-6 and pH 3.0 in columns 7-12. Rows A-D are performed with 2 cycles of 20 μL elution volume and rows E-H are performed with 4 cycles of 20 μL elution volume. The flow rate is 500 μL/min.

After the MEA instrument performs the programmed purification protocol for the 96 samples, and the amount of total purified ubiquitin purified from each extraction is quantified by HPLC. Increasing the number of capture cycles increases the recovery of the protein as much as 50%. There is improvement in all cases of 4 cycles vs. 2 cycles; 6 cycles vs. 4 cycles, etc. The pH 2.5 phosphoric acid eluting solvent increases recovery 5-30% over the pH 3.0 eluting solvent. The number of eluting cycles has very little effect on the recovery of the protein.

While the invention has been described in connection with specific embodiments thereof, it will be understood that it is capable of further modifications and this application is intended to cover and variations, uses, or adaptations of the invention that follow, in general, the principles of the invention, including such departures from the present disclosure as come within known or customary practice within the art to which the invention pertains and as may be applied to the essential features hereinbefore set forth. Moreover, the fact that certain aspects of the invention are pointed out as preferred embodiments is not intended to in any way limit the invention to such preferred embodiments.

What is claimed is:

1. A method of extracting an analyte from a sample solution, comprising the steps of:
(a) passing a sample solution containing an analyte through a pipette tip column, wherein said pipette tip column is comprised of a packed bed of extraction medium, and whereby said analyte adsorbs to the extraction medium;
(b) optionally passing a wash solution through the pipette tip column;
(c) passing a pre-elution wash solution through the pipette tip column, whereby said pre-elution wash solution removes base or buffer from the extraction medium; and
(d) passing a desorption solvent through the pipette tip column to elute the analyte, wherein the pH of the desorption solvent is 5 or lower.

2. The method of claim 1, wherein the volume of the desorption solvent is less than five times the volume of the bed of extraction medium.

3. The method of claim 2, wherein the volume of the desorption solvent is less than four times the volume of the bed of extraction medium.

4. The method of claim 3, wherein the volume of the desorption solvent is less than three times the volume of the bed of extraction medium.

5. The method of claim 4, wherein the volume of the desorption solvent is less than two times the volume of the bed of extraction medium.

6. The method of claim 1, wherein the extraction medium is a gel resin.

7. The method of claim 6, wherein the gel resin is agarose and sepharose.

8. The method of claim 1, wherein the extraction medium is an affinity resin.

9. The method of claim 8, wherein the affinity resin is selected from the group consisting of Protein A, Protein G, Protein L or IMAC.

10. The method of claim 1, wherein the pre-elution wash solution is water or saline solution.

11. The method of claim 1, wherein the analyte is a biomolecule.

12. The method of claim 11, wherein the biomolecule is a protein.

13. The method of claim 11, wherein the biomolecule retains biological activity.

14. A method of extracting a protein from a sample solution, comprising the steps of:
(a) passing a sample solution containing a protein through a pipette tip column, wherein said pipette tip column is comprised of a packed bed of extraction medium, wherein said extraction medium is comprised of agarose or sepharose, and whereby said analyte adsorbs to the extraction medium;
(b) optionally passing a wash solution through the pipette tip column;
(c) passing a pre-elution wash solution through the pipette tip column, whereby said pre-elution wash solution removes base or buffer from the extraction medium; and
(d) passing a desorption solvent through the pipette tip column to elute the protein, wherein the pH of the desorption solvent is 5 or lower.

15. The method of claim 14, wherein the protein retains biological activity.

16. The method of claim 14, wherein the extraction medium is an affinity resin.

17. The method of claim 16, wherein the affinity resin is selected from the group consisting of Protein A, Protein G, Protein L or IMAC.

18. The method of claim 17, wherein the protein retains biological activity.
